(19) United States
(12) Patent Application Publication
(10) Pub. No.: US 2025/0258008 A1
(43) Pub. Date: Aug. 14, 2025

(54) METHODS, SYSTEMS, AND DEVICES FOR AVOIDING PAROLEE VIOLATIONS

(71) Applicant: MOTOROLA SOLUTIONS, INC., CHICAGO, IL (US)

(72) Inventors: SIDDI A WAHEED, GREENACERS, FL (US); JOSEPH NAMM, PLANTATION, FL (US); CESAR D AGUILAR, WESTON, FL (US); BARBARA R DOUTRE, PLANTATION, FL (US)

(21) Appl. No.: 18/437,300

(22) Filed: Feb. 9, 2024

(51) Int. Cl. G01C 21/34; G06Q 50/18

(52) U.S. Cl. CPC G01C 21/3484; G01C 21/3461; G06Q 50/18

(57) ABSTRACT

A method and apparatus for obtaining a drive request from a first communication device registered with a driving service, the drive request identifying a source location and a destination location. Further embodiments include identifying that an individual associated with the drive request is currently subject to a legal restriction, the legal restriction restricting mobility of the individual. Additional embodiments include generating custom drive route for the drive request between the source location and the destination location that satisfies the legal restriction and providing the custom drive route to a second communication device of a driver associated with the driving service, without presenting a first notification on the second communication device of the legal restriction. Other embodiments are disclosed.

### BACKGROUND OF THE INVENTION

Parolees are subject to legal restrictions upon release from incarceration. The legal restrictions can include movement or location restrictions. Movement restriction can be due to a restraining order associated with a protected person. Location instructions can include avoiding known areas of criminal activity or persons or places relating to criminal activity or a prior conviction. While traveling, parolees may not be aware that they are unintentionally close to violating such restrictions. That is, a parolee may be driving near a restricted area or a restricted person without being aware of the nature of the area, or the people located within the area, thereby unintentionally and/or unknowingly violating their parole.

Accordingly, there is a need for methods, systems, and devices for avoiding such parolee violations.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for avoiding parolee violations in accordance with some embodiments.

FIGS. 2A, 2B, 3A, 3B, and 3C are flowcharts of methods of avoiding parolee violations in accordance with some embodiments.

FIG. 4 is a block diagram of system describing a computing environment in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One or more embodiments include a communication system, comprising a server including a processor, and a memory that stores executable instructions that, when executed by the server, facilitate performance of operations. The operations comprise obtaining a drive request from a first communication device registered with a driving service, the drive request identifying a source location and a destination location. Further operations comprise identifying that an individual associated with the drive request is currently subject to a legal restriction, the legal restriction restricting mobility of the individual. Additional operations can comprise generating custom drive route for the drive request between the source location and the destination location that satisfies the legal restriction and providing the custom drive route to a second communication device of a driver associated with the driving service, without presenting a first notification on the second communication device of the legal restriction.

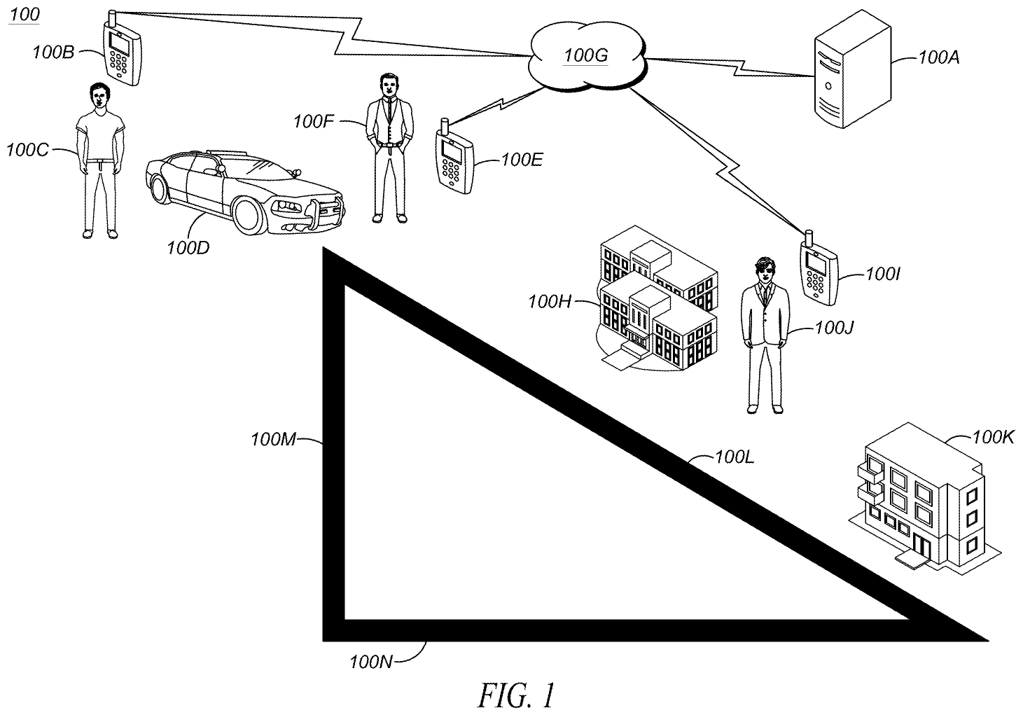

FIG. 1 is a block diagram of a system 100 for avoiding parolee violations in accordance with some embodiments. System 100 can include a server 100a communicatively coupled, over a communication network 100g, to a communication device 100b associated with a parolee 100c. Further, a communication device 100e associated with a driver 100f is communicatively coupled to server 100a over communication network 100g. Vehicle 100d is associated with the driver 100f. Both vehicle 100d and driver 100f can be associated with a rideshare service and/or a rideshare software application, among other possibilities. In addition, a communication device 100i associated with a protected person 100j can be communicatively coupled to server 100a over communication network 100g. Communication network 100g can comprise a wireless communication network, a wired communication network, or a combination thereof. Further, server 100a can comprise one or more servers in one location, one or more servers spanning multiple locations, one or more virtual servers in one location, one or more servers spanning multiple locations, one or more cloud servers, or a combination thereof. Each of communication device 100b, communication device 100e, and communication device 100i can comprise a smartphone, a mobile phone, a mobile device, a tablet computer, a laptop computer, a desktop computer, or any other computing device.

In one or more embodiments, a school 100h can be an entity and/or location that comprises a restricted area for the parolee 100c as part of its legal restriction determined upon release from their incarceration. Also, a home 100k can be associated with the parolee 100c. Road 100l can be a path between the parolee's current location and their home 100k. Further, road 100m and road 100n can comprise an alternate path to home 100k from the current location of the parolee 100c.

In one or more embodiments, server 100a can obtain a drive request from communication device 100b registered with a driving service (e.g., rideshare service). The drive request can identify a current location of the parolee and a destination location (e.g., home 100k). Further, the server 100a, utilizing a software application, can identify that an individual (e.g., parolee 100c) associated with the drive request is currently subject to a legal restriction. The legal restriction restricts mobility of the individual. In some embodiments, the legal restriction can include a restraining order against the parolee 100c such that they cannot be within a predetermined distance of protected person 100j. In other embodiments, the legal restriction can include that the parolee 100c cannot be within a predetermined distance of school 100h. In additional embodiments, the protected person 100j can be located within the school 100h. In further embodiments, the communication device 100i associated with the protected person 100j can be registered with server 100a via the software application utilized by the server 100a and identify that the protected person 100j is subject to a restraining order included in the legal restriction associated with parolee 100c. Some embodiments can include a local or global database that stores legal restrictions relevant to a group of parolees. The server 100a, via the software application, can access the legal restriction pertaining to parolee 100c from such a database via an API or some other software mechanism. Moreover, the identifying that the parolee 100c is subject to the legal restriction can comprise identifying a current location of the protected person 100j subject to the restraining order associated with the legal restriction substantially at a time of the driving request.

In one or more embodiments, the server 100a can generate a custom drive route for the drive request between the current location and the destination location (e.g., home 100k) that satisfies the legal restriction. Thus, the drive route comprises road 100m and road 100n, avoiding road 100l and placing the parolee 100c in proximity to school 100h and/or protected person 100j, thereby avoiding one or more violations of their parole. Note, without being subject to the legal restriction, the drive route may have included road 100l, a more direct and/or time saving path to home 100k. Once the custom drive route (which may, accordingly, be less direct or take more time compared to a route without the legal restriction) is generated, the server 100a can provide the custom drive route to communication device 100e of driver 100f associated with the driving service (e.g., rideshare service) as a mandatory route. In one embodiment, the custom drive route is provided to communication device 100e without presenting a notification on the communication device 100e of the legal restriction associated with the parolee 100c or that the route is less than optimal in order to maintain the parolee's privacy.

In one embodiment, the custom drive route provided to driver 100f on communication device 100e can include an indication that the custom drive route is a nonoptimal path between the source location and the destination location, and must be followed (e.g., mandatory). In another embodiment, the custom drive route can be provided to driver 100f on communication device 100e without any indication that the custom drive route is a nonoptimal path. However, if the driver 100f deviates from the custom drive route, the software application on server 100a can provide an additional/secondary notification when the driver 100f approaches the restricted area such that the additional secondary notification indicates to the driver to avoid the restricted area. Alternatively, the additional/secondary notification can indicate that the custom drive route is mandatory.

In one or more embodiments, the legal restriction can comprise different aspects. In some embodiments, the legal restriction pertains to one or more court orders to stay away a predetermined distance away from each of a group of predetermined entities. Further, the group of predetermined entities can include one or more people, places, and objects. In other embodiments, the legal restriction can pertain to one of restraining orders (e.g., people), schools (e.g., locations), known drug dealers, liquor stores, criminal activity, or a combination thereof.

In one or more embodiments, the server 100a, via the software application, can receive a request for the current location of the protected person 100j and in response to receiving the request and determining that no route is possible that does not violate the restriction(s), the server 100a, via the software application, either determines not to respond to the request based on the privacy concerns of the protected person 100j in the restraining order or provides a message indicating that a route could not be provided at this time or falsely that a driver could not be found, among other possibilities. This is to ensure that the parolee 100c is not provided any indication of the current location of the protected person 100j, thereby violating the restraining order that includes a directive to maintain the location of the protected person private from the parolee 100c.

In alternative embodiments, the restraining order may not include a directive to maintain the current location of the protected person 100j private to allow the parolee 100c an opportunity to avoid the protected person 100j. Thus, the server 100a can receive user-generated input from communication device 100b of the parolee 100c. The user-generated input includes a request for the current location of the protected person 100j by the restraining order. In response to receiving the user-generated input, the server 100a, utilizing the software application, can determine to respond to the second request based on the restraining order. Further, the server 100a, utilizing the software application, can generate a notification that includes the current location of the protected person 100j by the restraining order. In addition, the server 100a, utilizing the software application, can provide the notification to communication device 100b. The communication device 100b presents the notification to the parolee 100c.

In one or more embodiments, the software application can comprise a rideshare software application. In other embodiments, the software application can be a safety software application. In further embodiments, the software application can comprise a rideshare software application working in conjunction with the safety software application.

In one or more embodiments, the request for a drive route that includes a source location and a destination location can be obtained by the rideshare application from communication device 100b. Further, the drive route request including the source location and the destination location as well as the identity of the parolee 100c can be provided to the safety software application via an application programming interface (API). The safety software application can generate the custom drive route based on the legal restriction of the parolee 100c and then provide the custom drive route to the rideshare software application via the API. Moreover, the rideshare software application can provide the custom drive route to communication device 100e of the driver 100f.

In one or more embodiments, the request for a drive route that includes a source location and a destination location can be obtained by the safety software application from communication device 100b. The safety software application can generate the custom drive route based on the legal restriction of the parolee 100c and then provide the custom drive route to the rideshare software application via the API. Moreover, the rideshare software application can provide the custom drive route to communication device 100e of the driver 100f.

In one or more embodiments, the server 100a, via a software application, can generate an optimal route for the individual between the source location and the destination location that is not based on the legal restriction and generate the custom drive route for the individual between the source location and the destination location that is based on the legal restriction. Further, if the legal restriction allows (e.g., the legal restriction includes a non-restraining order-type restriction that does not compromise the privacy of a protected person) the individual to receive both the optimal route and the custom drive route, then the software application can provide both the optimal route and the custom drive route to the communication device of the individual and presented on its display indicated that the custom drive route is generated to avoid a parolee violation. In some embodiments, the optimal route and the custom drive route can be presented in different colors. In other embodiments in which the legal restriction comprises a restraining order, the individual can be provided only the custom drive route. Depending on the restrictions in the restraining order, the custom drive route in such embodiments can be provided with or without an indication that the custom drive route is modified to avoid a parolee violation. Any embodiment which the individual is provided an optimal route and/or a custom drive route, such optimal route and/or custom drive route is provided independent of the route provided to the driver of the rideshare software application.

Although embodiments discussed herein describe a rideshare software application to be used by a parolee 100c, in alternative embodiments, the parolee 100c can utilize a map software application, a public transportation software application or any other software application that generates a route for the parolee 100c to travel between a source location and the destination location. Although FIG. 1 illustrates only one restriction and one reroute, in other embodiments, a parolee may be subject to multiple restrictions causing multiple reroutes in the determined route from source to destination for the parolee.

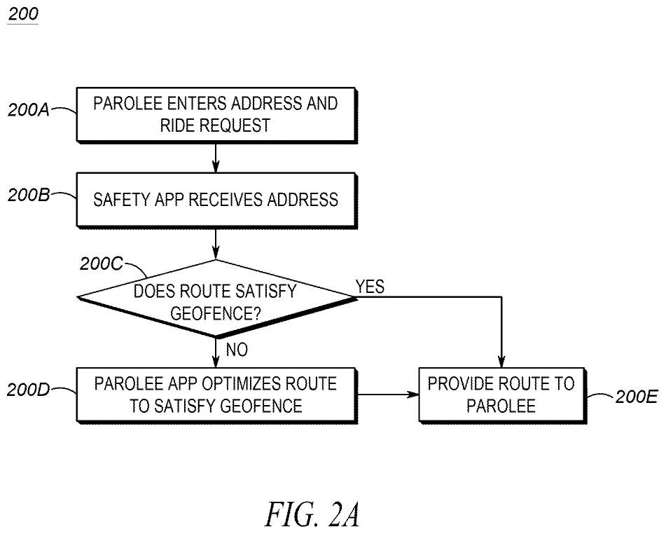

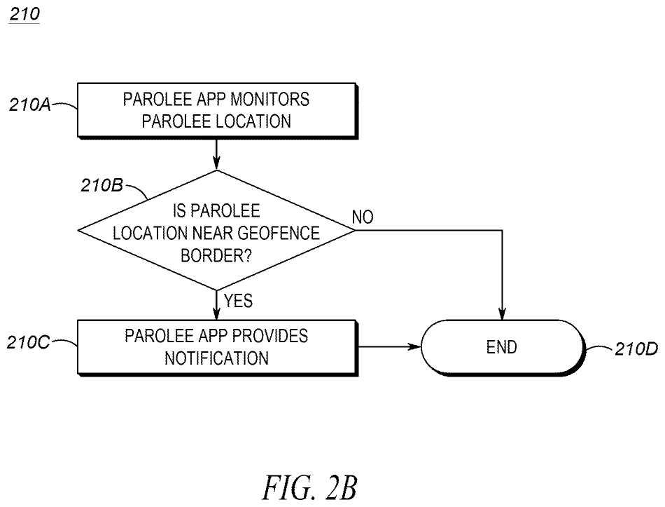

FIG. 2A is a flowchart of a method 200. In one or more embodiments, aspects of method 200 can be implemented by a communication device associated with a parolee or a server, or both working in concert. The method 200 can include, at 200a, the parolee entering into the communication device a destination address and ride/drive request via a rideshare service. Further, the method 200 can include the server, at 200b, receiving the address and the drive request via a safety software application. The server, utilizing the safety software application, can generate a drive route. In addition, the method 200 can include the server, at 200c, determining whether the drive route satisfies a geofence restriction due to the legal restriction associated with the parolee. The geofence restriction is a virtual geographic boundary generated by a global position system (GPS) accessible by or generated in conjunction with the safety software application based on the legal restriction. If the server determines that the drive route satisfies the geofence restriction, then the method 200 can include the server, at 200e, providing the drive route to the communication device of the parolee or of the driver. If the server determines that the drive route does not satisfy the geofence restriction, then the method 200 can include the server, at 200d, modifying the drive route to satisfy the geofence utilizing the safety software application before proceeding to 200e.

FIG. 2B is a flowchart of a method 210. In one or more embodiments, aspects of method 210 can be implemented by a communication device associated with a parolee or a server, or both working in concert. The method 210 can include the server, utilizing a safety software application, at 210a, monitoring the parolee location by determining the location of the communication device of the parolee at regular time intervals. Further, the method 210 can include the server, utilizing the safety software application, at 210b, determining that a current location of the communication device of the parolee is near a geofence border (e.g., a predetermined threshold distance away from a restricted area). If the server, utilizing the safety software application, determines that the current location is not near a geofence border, then the server provide no notification to the communication device of the parolee and the method 210 ends at 210d. However, if the server, utilizing the safety software application, determines that the current location is near a geofence border (e.g., a predetermined threshold distance away from a restricted area), then the server, utilizing the safety software application, at 210c, provides a notification to the communication device of the parolee and the method 210 ends at 210d.

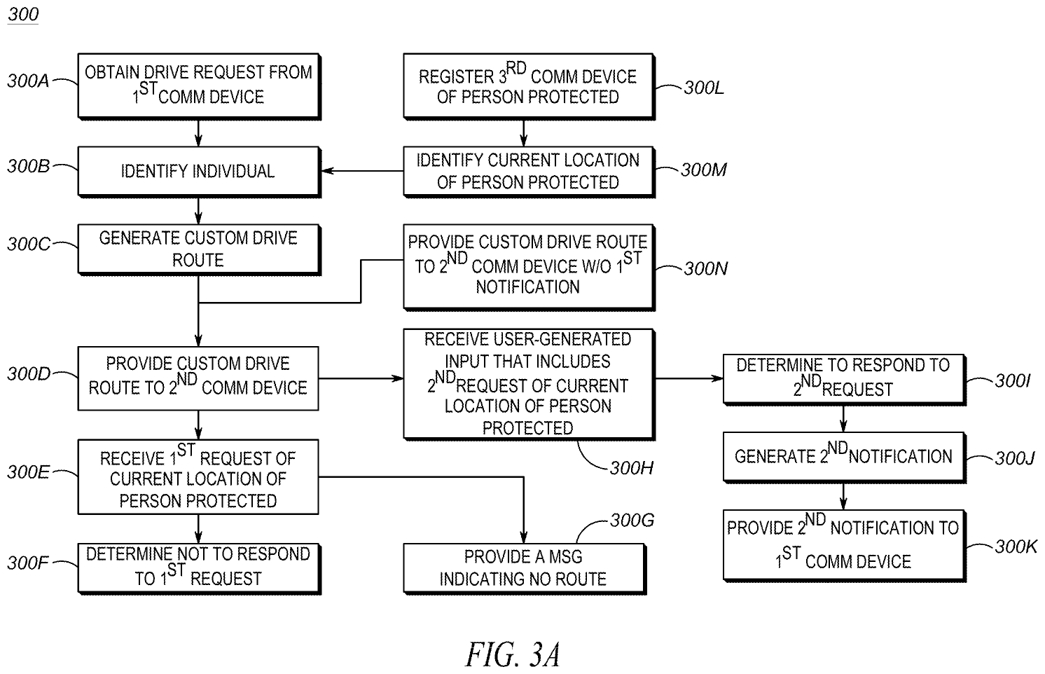

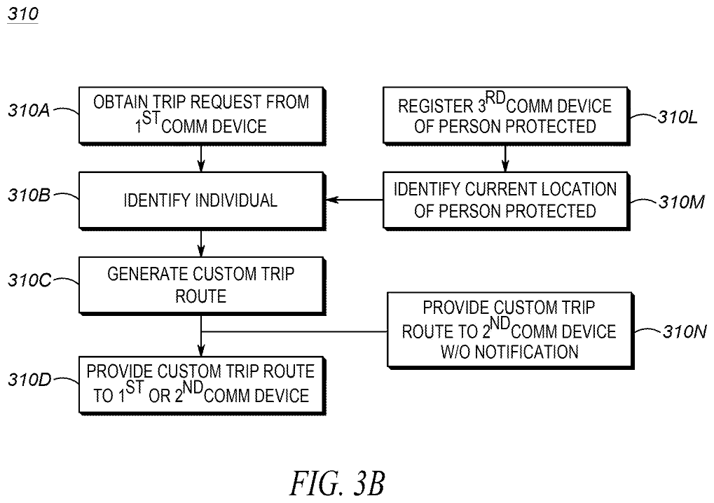

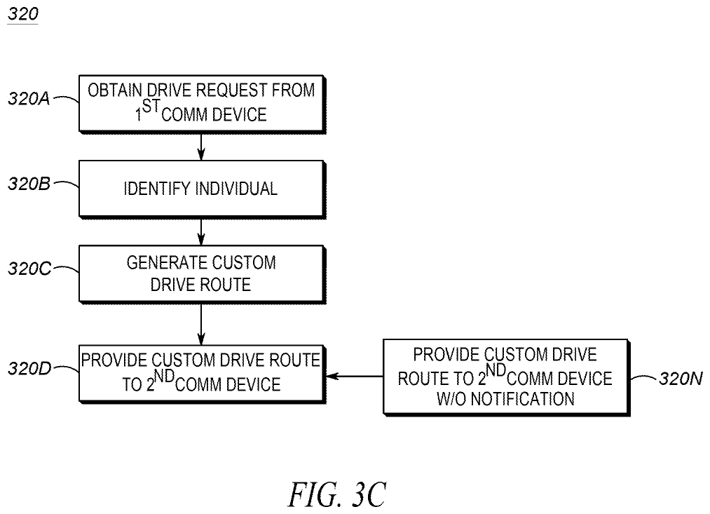

FIG. 3A is a flowchart of a method 300. In one or more embodiments, aspects of method 300 can be implemented by a server utilizing a safety software application and/or a rideshare software application. The method 300 can include the server, at 300a, obtaining a drive request from a first communication device registered with a driving service. The drive request identifying a source location and a destination location. Further, the method 300 can include the server, at 300b, identifying that an individual associated with the drive request is currently subject to a legal restriction. The legal restriction can restrict mobility of the individual. In addition, the method 300 can include the server, at 300c, generating a custom drive route for the drive request between the source location and the destination location that satisfies the legal restriction.

In one or more embodiments, the method 300 can include the server, at 300d, providing the custom drive route to a second communication device of a driver associated with the driving service as a mandatory route. In additional embodiments, the custom drive route is provided, at 300n, without presenting a first notification on the second communication device of the legal restriction. In one embodiment, the custom drive route provided to the driver on second communication device can include an indication that this is a nonoptimal path between the source location and the destination location, and must be followed (e.g., mandatory). In another embodiment, the custom drive route can be provided to the driver on the second communication device without any indication that the custom drive route is a nonoptimal path. However, if the driver deviates from the custom drive route, the software application on server can provide an additional/secondary notification when the driver approaches the restricted area such that the additional secondary notification indicates to avoid the restricted area. Alternatively, the additional/secondary notification can indicate that the custom drive route is mandatory.

In some embodiments, the legal restriction pertains to one or more court orders to stay away a predetermined distance away from each of a group of predetermined entities. Further, the group of predetermined entities can be selected from one or more of people, places, and objects. In other embodiments, the legal restriction can pertain to a group selected from one of restraining orders, schools, known drug dealers, liquor stores, areas of criminal activity, or a combination thereof. In further embodiments, the legal restriction comprises avoiding any routes that come within a predetermined distance to any school.

In one or more embodiments, the method 300 can include the server, at 300l, registering a third communication device of a person protected by a restraining order. Further, the method 300 can include the server, at 300m, identifying a current location of the person protected by the restraining order at a time of the driving request. In some embodiments, the identifying that the individual is currently subject to the legal restriction comprises identifying a current location of the person protected by the restraining order at a time of the driving request. In addition, the method 300 can include the server generating the custom driving route by avoiding coming within a predetermined distance of the current location of the person protected. In other embodiments, the generating the custom drive route that satisfies the legal restriction comprises generating the custom driving route by avoiding coming within a predetermined distance of the current location of the person protected.

In one or more embodiments, the method 300 can include the server, at 300e, receiving a first request for the current location of the person protected by the restraining order. Further, the method 300 can include the server, at 300f, determining not to respond to the first request based on the restraining order based on the privacy concerns of the person protected in the restraining order. In addition, the method 300 can include the server, at 300g, providing a message indicating that a route could not be provided at this time due to the privacy concerns.

In one or more embodiments, the method 300 can include the server, at 300h, receiving user-generated input from the first communication device of the individual. The user-generated input includes a second request for the current location of the person protected by the restraining order. Further, the method 300 can include the server, at 300i, in response to receiving the user-generated input, determining to respond to the second request based on the restraining order having no privacy concerns regarding the person protected. In addition, the method 300 can include the server, at 300j, generating a second notification that includes the current location of the person protected by the restraining order. Also, the method 300 can include the server, at 300k, providing the second notification to the first communication device. The first communication device presents the notification to the individual.

FIG. 3B is a flowchart of a method 310. In one or more embodiments, aspects of method 310 can be implemented by a server utilizing a software application. The method 310 can include the server, at 310a, obtaining a trip request from a first communication device registered with a trip software application. The trip request identifying a source location and a destination location. The first communication device is associated with an individual. Further, the method 310 can include the server, at 310b, identifying that the individual associated with the trip request is currently subject to a legal restriction. The legal restriction can restrict mobility of the individual. In addition, the method 310 can include the server, at 310c, generating a custom trip route for the trip request between the source location and the destination location that satisfies the legal restriction. Also, the method 310 can include the server, at 310d, providing the trip route to one of the first communication device or a second communication device as a mandatory route. The first communication device is associated with the individual. The trip software application can be one of a map software application, a public transportation software application, and a rideshare software application. The second communication device is associated with a driver associated with the rideshare software application. In some embodiments, the providing of the trip route to the second communication device comprises providing the trip route to the second communication device without presenting a notification on the second communication device of the legal restriction.

In one or more embodiments, the trip route can comprise an optimized trip route. The legal restriction can pertain to court orders to stay a predetermined distance away from each of a group of predetermined entities. The group of predetermined entities can be selected from one or more of people, places, and objects. The legal restriction can pertain to a group selected from one of restraining orders, schools, known drug dealers, and liquor stores.

In one or more embodiments, the method 310 can include the server, at 3101, registering a third communication device of a person protected by a restraining order. Further, the method 310 can include the server, at 310m, identifying a current location of the person protected by the restraining order at a time of the trip request. In some embodiments, the identifying of the individual is currently subject to the legal restriction comprises identifying a current location of the person protected by the restraining order at a time of the trip request. In addition, the method 310 can include the server, at 310n, generating the trip route by avoiding coming within a predetermined distance of the current location of the person protected. In other embodiments, the generating the trip route comprises generating the trip route by avoiding coming within a predetermined distance of the current location of the person protected.

FIG. 3C is a flowchart of a method 320. In one or more embodiments, aspects of method 320 can be implemented by a server utilizing a software application. The method 320 can include the server, at 320a, obtaining a drive request from a first communication device registered with a rideshare software application. The drive request identifying a source location and a destination location. Further, the method 320 can include the server, at 320b, identifying that an individual associated with the drive request is currently subject to a legal restriction. The legal restriction can restrict mobility of the individual. In addition, the method 320 can include the server, at 320c, generating a custom drive route for the drive request between the source location and the destination location that satisfies the legal restriction. Also, the method 320 can include the server, at 320d, providing the drive route to a second communication device of a driver associated with the rideshare software application as a mandatory route. Further, the method 320 can include the server, at 320n, providing the drive route to a second communication device of a driver associated with the rideshare software application as a mandatory route. In some embodiments, the drive route can be provided without presenting a notification on the second communication device of the legal restriction.

While for purposes of simplicity of explanation, the respective processes are shown and described as a series of blocks in FIGS. 2A, 2B, 3A, 3B, and 3C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, one or more blocks in FIGS. 2A, 2B, 3A, 3B, and 3C can be performed in response to, or in conjunction with, one or more other blocks in FIGS. 2A, 2B, 3A, 3B, and 3C.

Portions of some embodiments can be implemented with portions of other embodiments.

Aspects of embodiments described herein can be implemented by one or more software applications stored in a non-transitory machine-readable (or computer-readable) storage medium.

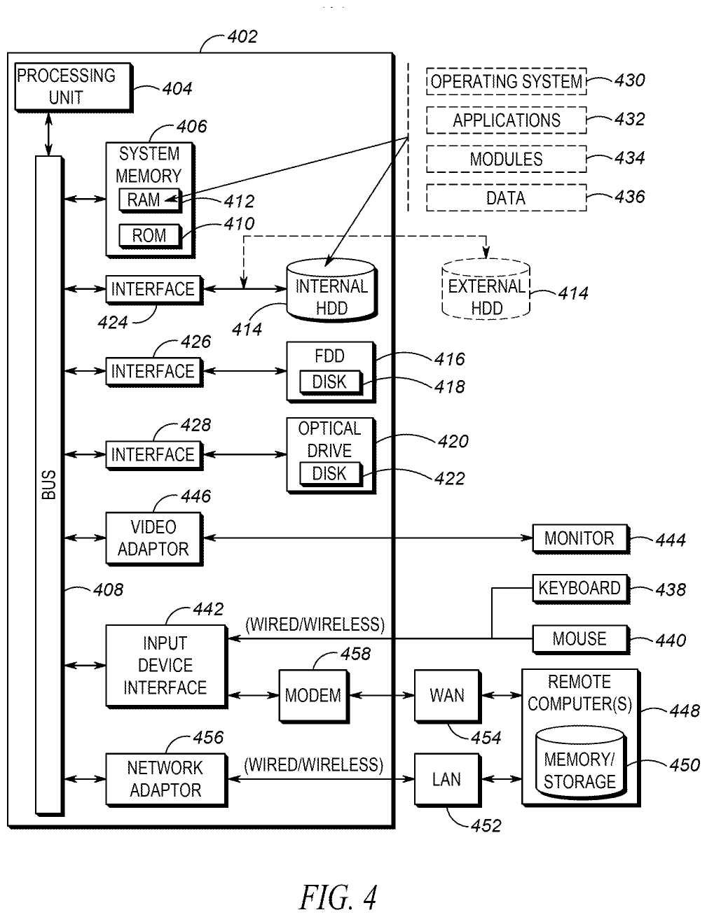

FIG. 4 is a block diagram of system describing a computing environment in accordance with some embodiments. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of communication devices and servers described herein. Each of these devices can be implemented via computer-executable instructions that can run on one or more computers, and/or in combination with other program modules and/or as a combination of hardware and software. For example, computing environment 400 can facilitate in whole or in part determining a trip route for a parolee to avoid violating parole. Each of server 100a, communication device 100b, communication device 100e, and communication device 100i can comprise computing environment 400.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A communication system, comprising:
a server including a processor; and
a memory that stores executable instructions that, when executed by the server, facilitate performance of operations, the operations comprising:
obtaining a drive request from a first communication device registered with a driving service, the drive request identifying a source location and a destination location;
identifying that an individual associated with the drive request is currently subject to a legal restriction, wherein the legal restriction restricts mobility of the individual;
generating a custom drive route for the drive request between the source location and the destination location that satisfies the legal restriction; and
providing the custom drive route to a second communication device of a driver associated with the driving service, without presenting a first notification on the second communication device of the legal restriction.

2. The communication system of claim 1, wherein providing of the custom drive route to the second communication device of the driver comprises providing an indication that the custom drive route is a nonoptimal path between the source location and the destination location that is to be followed by the driver.

3. The communication system of claim 1, wherein the legal restriction pertains to one or more court orders to stay away a predetermined distance away from each of a group of predetermined entities.

4. The communication system of claim 3, wherein the group of predetermined entities is selected from one or more of people, places, and objects.

5. The communication system of claim 1, wherein the legal restriction pertains to a group selected from one of restraining orders, schools, known drug dealers, and liquor stores.

6. The communication system of claim 1, wherein the operations further comprise:
registering a third communication device of a person protected by a restraining order, wherein identifying that the individual is currently subject to the legal restriction comprises the identifying a current location of the person protected by the restraining order at a time of the driving request, wherein the generating the custom drive route comprises generating the custom driving route by avoiding coming within a predetermined distance of the current location of the person protected.

7. The communication system of claim 1, wherein the operations comprise generating an optimal route between the source location and the destination location.

8. The communication system of claim 7, wherein the operations further comprise providing the optimal route and the custom route to the first communication device of the individual, wherein the custom route is presented on the first communication device with an indication that the custom route is generated to avoid a parolee violation.

9. The communication system of claim 1, wherein the legal restriction comprises avoiding any routes that come within a predetermined distance to any school.

10. A non-transitory machine-readable medium, comprising executable instructions that, when executed by a server including a processor, facilitate performance of operations, the operations comprising:
obtaining a trip request from a first communication device registered with a trip software application, the trip request identifying a source location and a destination location, wherein the first communication device is associated with an individual;
identifying that the individual associated with the trip request is currently subject to a legal restriction, wherein the legal restriction restricts mobility of the individual;
generating a custom trip route for the trip request between the source location and the destination location that satisfies the legal restriction; and
providing the trip route to one of the first communication device or a second communication device as a mandatory route.

11. The non-transitory machine-readable medium of claim 10, wherein the first communication device is associated with the individual.

12. The non-transitory machine-readable medium of claim 10, wherein the trip software application is selected from a group including one of a map software application, a public transportation software application, and a rideshare software application.

13. The non-transitory machine-readable medium of claim 12, wherein the second communication device is associated with a driver associated with the rideshare software application.

14. The non-transitory machine-readable medium of claim 13, wherein the providing of the trip route to the second communication device comprises providing the trip route to the second communication device without presenting a notification on the second communication device of the legal restriction.

15. The non-transitory machine-readable medium of claim 10, wherein the trip route comprises an optimized trip route.

16. The non-transitory machine-readable medium of claim 15, wherein the legal restriction pertains to court orders to stay a predetermined distance away from each of a group of predetermined entities.

17. The non-transitory machine-readable medium of claim 16, wherein the group of predetermined entities is selected from one or more of people, places, and objects.

18. The non-transitory machine-readable medium of claim 10, wherein the legal restriction pertains to a group selected from one of restraining orders, schools, known drug dealers, and liquor stores.

19. The non-transitory machine-readable medium of claim 10, wherein the operations further comprise:
registering a third communication device of a person protected by a restraining order, wherein the identifying of the individual is currently subject to the legal restriction comprises identifying a current location of the person protected by the restraining order at a time of the trip request, wherein the generating the trip route comprises generating the trip route by avoiding coming within a predetermined distance of the current location of the person protected.

20. A method, comprising:
obtaining, by a server including a processor, a drive request from a first communication device registered with a rideshare software application, the drive request identifying a source location and a destination location;
identifying, by the server, that an individual associated with the drive request is currently subject to a legal restriction, wherein the legal restriction restricts mobility of the individual;
generating, by the server, a custom drive route for the drive request between the source location and the destination location that satisfies the legal restriction; and
providing, by the server, the drive route to a second communication device of a driver associated with the rideshare software application as a mandatory route, without presenting a notification on the second communication device of the legal restriction.
